(19) United States
(12) Patent Application Publication
(10) Pub. No.: US 2010/0206825 A1
(43) Pub. Date: Aug. 19, 2010

(54) MERCHANDISE DISPLAY HOOK INCLUDING UNIVERSAL ADAPTER FOR MOUNTING TO VERTICAL SUPPORT

(76) Inventors: Michael R. Johnston, Waxhaw, NC (US); Gregory C. Schultz, Huntersville, NC (US); John F. Roberts, Charlotte, NC (US)

Correspondence Address: Christopher C. Dremann, P.C., 15015 Lancaster Highway, Charlotte, NC, 28277, US

(21) Appl. No.: 12/706,640

(22) Filed: Feb. 16, 2010

Related U.S. Application Data
(60) Provisional application No. 61/152,888, filed on Feb. 16, 2009.

(51) Int. Cl. A47F 5/08; F16M 13/02; B23P 17/04

(52) U.S. Cl. 211/59.2; 248/220.21; 29/428

(57) ABSTRACT

A merchandise display hook for supporting and displaying items of merchandise includes a universal adapter and a mounting bracket for mounting the display hook to a generally vertical support, for example slatwall. The universal adapter includes one of a pair of attachment tracks and attachment rails for engaging the other of a pair of attachment tracks and attachment rails on the mounting bracket to attach the universal adapter to the mounting bracket from a generally lateral direction. The universal adapter may further include a lower portion for engaging the support to prevent the display hook from being tilted in a downwards direction. The mounting bracket may include flanges on upper and lower portions of a rear wall for engaging a channel formed in the support. Alternatively, the mounting bracket may include a body portion and a mounting plate movably disposed on the body portion for engaging the channel formed in the support. The display hook further includes a lockable base movable between an unlocked position and a locked position to lock the display hook on the support.

### CROSS REFERENCE TO RELATED APPLICATION

This non-provisional application claims the benefit of priority of U.S. Provisional Patent Application No. 61/152,888, filed on Feb. 16, 2009, the entire disclosure of which is incorporated herein by reference.

### BACKGROUND OF THE INVENTION

The invention relates generally to merchandise display hooks for supporting and displaying items of merchandise on a vertical support. More particularly, the invention relates to a merchandise display hook including a universal adapter for readily mounting different display hooks to a common type of vertical support. In preferred embodiments, the invention is a merchandise display hook including a universal adapter and a mounting bracket configured for mounting the display hook to a slatwall type of vertical support from a lateral direction.

It is common practice for retailers to display smaller items of merchandise on display hooks mounted to a vertical support. The merchandise display hooks allow a potential purchaser to examine a product prior to purchasing the item. At the same time, the merchandise display hooks permit the retailer to stock multiple items of merchandise on each display hook in a limited amount of space, thereby increasing the number of items of merchandise and the number of different products that can be displayed on the vertical support, while reducing the frequency with which store personnel must stock the items. The relatively small size of the items and the larger number of items on each display hook, however, makes the display hook an attractive target for shoplifters. The shoplifter may attempt to remove all of the items of merchandise from the display hook at one time, referred to in the art as “sweeping,” or may attempt to remove the display hook along with the items from the vertical support by pulling, twisting or tilting the display hook in an upwards or downwards direction. In response to these threats, display hooks have been developed that include an anti-sweeping feature and a locking mechanism for locking the display hook to the vertical support. For reasons of cost, expediency and convenience it would be advantageous for a retailer to be able to inventory different merchandise display hooks having anti-sweep features and locking mechanisms for locking the display hook to a common type of vertical support.

Pegboard, wire grid, horizontal bar rack and slatwall (also referred to as slot wall or slatboard) are some of the common types of vertical supports to which merchandise display hooks are mounted. Use of the slatwall type of vertical support has increased due to its aesthetic appearance, structural integrity and versatility. In particular, slatwall includes a plurality of vertically spaced, horizontally-extending channels configured to receive a mounting bracket of the display hook in sliding engagement with at least one of the channels. As a result, the location of a merchandise display hook on the slatwall can be adjusted laterally along the channel a desired amount to optimize the horizontal spacing between adjacent display hooks or the vertical spacing between items of merchandise on adjacent display hooks. In this manner, a retailer is able to take full advantage of the space, commonly referred to as the retail footprint, available on the slatwall. It is difficult in most instances, and impossible in some, however, to take full advantage of the retail footprint available on the slatwall if the merchandise display hook must be tilted more than a minimal amount in an upwards or downwards direction to insert the mounting bracket of the display hook into a horizontally-extending channel of the slatwall.

Mechanical stops, such as vertically-extending end members, are typically provided on the lateral sides of the slatwall (Le. the opposed ends of the horizontally-extending channels) to prevent a merchandise display hook from being moved in a lateral direction out of a channel and off the slatwall. As previously mentioned, the adapter and mounting bracket permit the merchandise display hook to be readily mounted on the slatwall. If accessible, however, the adapter and mounting bracket also permit the entire display hook, along with the items of merchandise, to be tilted in an upwards or downwards direction and removed from the slatwall. Thus, a shoplifter thwarted by an anti-sweeping feature from sweeping all of the items of merchandise from the display hook at one time may instead resort to pulling, twisting or tilting the display hook in an upwards or downwards direction to remove the display hook along with the items of merchandise from the slatwall. Accordingly, any locking mechanism for locking the display hook on the slatwall must prevent access to the adapter and mounting bracket that mount the display hook to the slatwall.

Accordingly, there exists an unresolved need for a merchandise display hook for supporting and displaying items of merchandise on a vertical support that includes an anti-sweeping feature, a locking mechanism and a universal adapter configured for cooperating with a mounting bracket to readily mount different display hooks to a common type of vertical support. There exists a further need for an adapter and mounting bracket for mounting a merchandise display hook to a common type of vertical support that does not require the display hook to be tilted in an upwards or downwards direction to mount the display hook on the vertical support. There exists a still further need for a merchandise display hook including an adapter and a mounting bracket configured for mounting the display hook on slatwall from a lateral direction. There exists yet a further need for a merchandise display hook including an adapter and mounting bracket for mounting the display hook to a vertical support, and a locking mechanism for locking the display hook to the vertical support that prevents access to the adapter and mounting bracket.

### SUMMARY OF THE INVENTION

The above and other needs and advantages are provided by a merchandise display hook for supporting and displaying items of merchandise according to the present invention. In one aspect, the display hook includes at least one rod extending outwardly from a generally vertical support, a universal adapter attached to the at least one rod, and a mounting bracket for mounting the display hook to the support. The mounting bracket is configured to be received on the support and configured to receive the universal adapter thereon from a generally lateral direction.

In one embodiment, the mounting bracket includes a front wall disposed outwardly from the support having at least one attachment rail, and the universal adapter includes at least one attachment track for engaging the at least one attachment rail of the mounting bracket. The attachment track of the universal adapter is complimentary in shape to the attachment rail of the mounting bracket.

In another embodiment, the merchandise display hook further includes a lockable base for locking the display hook to the support. The lockable base is movably disposed on the rod between an unlocked position and a locked position, and prevents access to the universal adapter in the locked position. The lockable base may include a magnetically attractable locking member for engaging the rod to lock the lockable base on the rod, and a magnet may be operable for releasing the locking member from engagement with the rod to unlock the lockable base from the rod. Regardless, the lockable base prevents the display hook from being tilted upwards or downwards to dislodge the display hook from the support.

In yet another embodiment, the universal adapter includes an upper portion having a pair of attachment tracks for engaging a complimentary pair of attachment rails of the mounting bracket, and further includes a lower portion for engaging the support to prevent the display hook from being tilted downwards to dislodge the display hook from the support.

In yet another embodiment, the mounting bracket further includes a rear wall having a flange disposed on an upper portion for engaging a channel formed in the support and a flange disposed on a lower portion for engaging the channel formed in the support. In an alternative embodiment, the mounting bracket includes a body portion having a pair of attachment rails for engaging a complimentary pair of attachment tracks of the universal adapter, and further includes a mounting plate for engaging a channel formed in the support. The mounting plate is movably mounted on the body portion of the mounting bracket and is movable relative to the body portion within the channel to secure the mounting bracket on the support.

In another aspect, the present invention provides a universal adapter and mounting bracket assembly for a merchandise display hook. The assembly includes an adapter attached to a rear portion of the merchandise display hook, the adapter including one of an attachment track and an attachment rail. The assembly further includes a mounting bracket configured for attachment to the support and including the other of the attachment track and the attachment rail. The one of the attachment track and the attachment rail of the adapter engages the other of the attachment track and the attachment rail of the mounting bracket from a generally lateral direction to mount the display hook on a support.

In yet another aspect, the present invention provides an adapter configured to engage a mounting bracket for mounting a merchandise display hook to a generally vertical support. The adapter includes an upper portion having a pair of vertically spaced attachment tracks for receiving a complimentary pair of attachment rails disposed on the mounting bracket, and a lower portion defining a mechanical stop for engaging the support to thereby prevent the merchandise display hook from being tilted downwards to dislodge the display hook from the support.

In yet another aspect, the present invention provides a method of mounting a merchandise display hook to a generally vertical support. The method includes providing a merchandise display hook having a universal adapter attached thereto and a lockable base that is movable between an unlocked position and a locked position. The method further includes providing a mounting bracket configured for attachment to the support. The method further includes attaching the mounting bracket to the support. The method further includes engaging one of an attachment track and an attachment rail of the universal adapter with the other of the attachment track and the attachment rail of the mounting bracket to attach the universal adapter to the mounting bracket and thereby mounting the display hook on the support. The method further includes moving the lockable base from the unlocked position to the locked position to thereby prevent access to the attachment track and the attachment rail of the universal adapter and the mounting bracket.

### BRIEF DESCRIPTION OF THE DRAWINGS

The following detailed description of the invention is best understood with reference to the accompanying drawing figures in which:

FIG. 1 is a front perspective view showing two different merchandise display hooks having anti-sweeping features and locking mechanisms for locking the display hook to a common type of a vertical support, namely slatwall.

FIG. 2 is a side view showing the merchandise display hooks of FIG. 1 mounted to the slatwall by a first embodiment of a mounting bracket according to the invention.

FIG. 3A is an enlarged side view of a portion of one of the merchandise display hooks and the mounting bracket of FIG. 2 illustrating the mounting bracket being partially positioned within the slatwall.

FIG. 3B is an enlarged side view of a portion of one of the merchandise display hooks and the mounting bracket of FIG. 2 illustrating the mounting bracket being fully positioned within the slatwall.

FIG. 3C is an enlarged front perspective view of a portion of one of the merchandise display hooks and the mounting bracket of FIG. 2 illustrating a universal adapter according to the invention affixed to the display hook being attached to the mounting bracket.

FIG. 3D is an enlarged side view of a portion of one of the merchandise display hooks and the mounting bracket of FIG. 2 illustrating a locking base disposed on the display hook being positioned to lock the display hook to the slatwall.

FIG. 4A is an enlarged front perspective view illustrating one of the merchandise display hooks and the mounting bracket of FIG. 2 being displaced laterally to reposition the display hook on the slatwall.

FIG. 4B is an enlarged front perspective view illustrating the universal adapter of one of the merchandise display hooks of FIG. 2 being displaced in a lateral direction to remove the display hook, from the mounting bracket.

FIG. 5 is a side view of the merchandise display hooks of FIG. 1 mounted to the slatwall by a second embodiment of a mounting bracket according to the invention.

FIG. 6 is an enlarged front perspective view showing the mounting bracket of FIG. 5 and illustrating the operation thereof.

FIG. 7A is an enlarged front perspective view illustrating the mounting bracket of FIG. 5 being positioned within the slatwall.

FIG. 7B is an enlarged front perspective view illustrating the mounting bracket of FIG. 5 being secured to the slatwall using a tool.

FIG. 7C is an enlarged front perspective view of a portion of one of the merchandise display hooks and the mounting bracket of FIG. 5 illustrating a universal adapter according to the invention affixed to the display hook being attached to the mounting bracket.

FIG. 7D is an enlarged side view of a portion of one of the merchandise display hooks and the mounting bracket of FIG. 5 illustrating a locking base disposed on the display hook being positioned to lock the merchandise display hook to the slatwall.

### DETAILED DESCRIPTION OF THE INVENTION

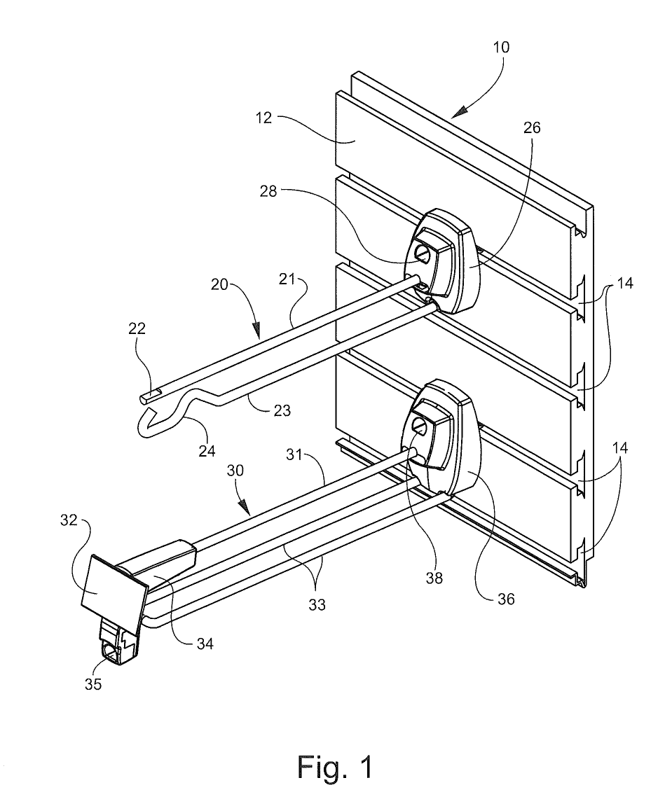

Referring now to the accompanying drawing figures wherein identical reference numerals denote like elements throughout the various views, FIG. 1 shows two merchandise display hooks 20, 30 mounted to a common type of a vertical support 10, namely slatwall 12, utilized for supporting and displaying items of merchandise (not shown for purposes of clarity) in a retail store. Other common types of vertical supports include pegboard, wire grid and horizontal bar rack. Slatwall (also referred to as slot wall or slatboard) has experienced increased usage in part due to its aesthetic appearance, structural integrity and versatility. Slatwall 12 includes a plurality of vertically spaced, horizontally-extending channels 14 configured to receive a mounting bracket (hidden from view in FIG. 1) of the display hook 20, 30 in sliding engagement with at least one of the channels. As a result, the location of the merchandise display hook 20, 30 on the slatwall 12 can be adjusted laterally along a channel 14 to optimize the horizontal spacing between adjacent display hooks or the vertical spacing between items of merchandise on adjacent display hooks. By adjusting the location of the merchandise display hooks 20, 30 in the lateral direction along the continuous channel 14, a retailer can take full advantage of the space, commonly referred to as the retail footprint, available on the slatwall 12. It is difficult in most instances, however, and impossible in some, for the retailer to take full advantage of the retail footprint available on the slatwall 12 if the merchandise display hooks 20, 30 must be tilted in an upwards or downwards direction more than a minimal amount to insert the mounting bracket of the display hook into the channel 14 of the slatwall. Furthermore, it is desirable that only authorized personnel be able to mount the merchandise display hooks 20, 30 on the slatwall 12, adjust the location of the display hooks in the lateral direction within the channel 14 on the slatwall, or remove the display hooks from the slatwall.

As shown herein, the merchandise display hook 20 mounted within a channel 14 on slatwall 12 is a conventional “2-wire” display hook comprising an upper rod (or wire) 21 and a lower rod (or wire) 23. The upper rod 21 has a notch or flat 22 formed therein at the free end for attaching an optional label holder (not shown) onto the display hook. The optional label holder receives a label bearing printed indicia, for example product and price information relating to the items of merchandise. The lower rod 23 of the display hook 20 has a series of bends at its free end to form an optional anti-sweeping feature 24. The anti-sweeping feature 24 is designed to increase the amount of time required to remove an item of merchandise from the display hook 20, and in some instances, permits only one item of merchandise to be removed at a time. Anti-sweeping feature 24 prevents a shoplifter from removing all of the items of merchandise from the display hook at one time, referred to in the art as “sweeping.” The merchandise display hook 20 further comprises an optional locking mechanism adjacent the opposite end for locking the display hook to the slatwall 12. As shown herein, the locking mechanism comprises a lockable base 26 that is slidably disposed on the upper rod 21 and movable thereon between an unlocked position and the locked position shown in FIG. 1. The lockable base 26 includes a D-shaped recess 28 for receiving a magnetic key (not shown) that releases a magnetically attractable locking member (not shown) from engagement with the upper rod 21 to thereby permit the lockable base to slide along the upper rod from the locked position to the unlocked position. A lockable base 26 suitable for use with the merchandise display hook 20 in the invention is shown and described in United States Patent Application Publication No. US 2008/0169250 A1 entitled SECURITY DEVICE FOR ATTACHING A PEG HOOK To A PEG SUPPORT and published Jul. 17, 2008, the entire disclosure of which is incorporated herein by reference. A magnetic key suitable for use with the lockable base 26 in the invention is shown and described in United States Patent Application Publication No. US 2008/0168811 A1 entitled MAGNETIC KEY FOR USE WITH A SECURITY DEVICE and published Jul. 17, 2008, the entire disclosure of which is incorporated herein by reference.

As shown herein, the merchandise display hook 30 mounted within a channel 14 on slatwall 12 is a conventional “3-wire” display hook comprising an upper rod (or wire) 31 and a pair of lower rods (or wires) 33 joined at the free end to form a U-shaped support for displaying items of merchandise. The display hook 30 includes an optional label holder 32, as previously described, that is formed on or secured to an optional locking mechanism adjacent the free end of the display hook. As shown herein, the locking mechanism is a lockable end assembly 34 that is slidably disposed on the upper rod 31 and is lockably disposed on the lower rods 33. The lockable end assembly 34 is movable on the upper rod 31 between an unlocked position and the locked position shown in FIG. 1 and includes a D-shaped recess 35 for receiving a magnetic key (not shown) that releases a magnetically attractable locking member (not shown) from engagement with the lower rods 33 to thereby permit the lockable base to slide along the upper rod 31 from the locked position to the unlocked position. In the locked position, the lockable end assembly 34 prevents removal of the items of merchandise from the display hook 30, and consequently, also serves as an anti-sweeping feature to prevent a shoplifter from removing all of the items of merchandise from the display hook at one time. A lockable end assembly 34 suitable for use with the display hook 30 in the invention is shown and described in United States Patent Application Publication No. US 2008/0209960 A1 entitled DISPLAY HOOK ASSEMBLY HAVING A SECURE FREE END and published Sep. 4, 2008, the entire disclosure of which is incorporated herein by reference. The merchandise display hook 30 further comprises an optional locking mechanism adjacent the opposite end for locking the display hook to the slatwall 12. As shown herein, the locking mechanism is a lockable base 36 that is slidingly disposed on the upper rod 31 and movable thereon between an unlocked position and the locked position shown in FIG. 1. The lockable base 36 includes a D-shaped recess 38 for receiving a magnetic key (not shown) that releases a magnetically attractable locking member (not shown) from engagement with the upper rod 31 to thereby permit the lockable base to slide along the upper rod 31 from the locked position to the unlocked position. A lockable base 36 suitable for use with the merchandise display hook 30 in the invention is shown and described in United States Patent Application Publication No. US 2008/0169250 A1 entitled SECURITY DEVICE FOR ATTACHING A PEG HOOK To A PEG SUPPORT and published Jul. 17, 2008, the entire disclosure of which is incorporated herein by reference. A magnetic key suitable for use with the lockable end assembly 34 and/or the lockable base 36 in the invention is shown and described in United States Patent Application Publication No. US 2008/0168811 A1 entitled MAGNETIC KEY FOR USE WITH A SECURITY DEVICE and published Jul. 17, 2008, the entire disclosure of which is incorporated herein by reference.

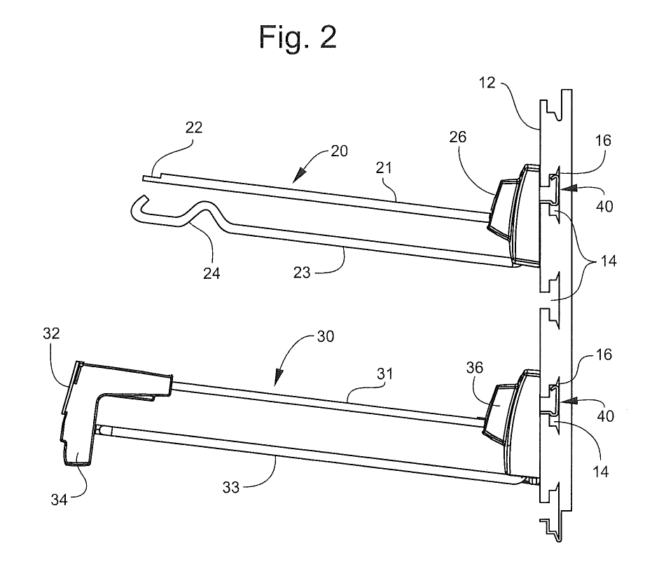

FIG. 2 is a side view showing the merchandise display hooks 20, 30 mounted within vertically-spaced, horizontally-extending channels 14 on the slatwall 12 by a first embodiment of a mounting bracket 40 according to the invention. As shown, the mounting bracket 40 is formed with a shape configured to engage a recess 16 formed within the channel 14. In particular, a lower portion of the mounting bracket is provided with a relatively smooth, continuous curvilinear shape that conforms to the lower portion of the recess 16 of the channel 14. An upper portion of the mounting bracket 40 is provided with a relatively smooth, continuous curvilinear shape in a reverse direction that terminates in an angled flange. The angled flange of the upper portion of the mounting bracket 40 is received in a “snap-fit” type engagement with the recess 16 of the channel 14 so that the mounting bracket is secured within the channel. The mounting bracket 40 is removable from the channel 14, as will be described in further detail, by tilting the mounting bracket upwards relative to the slatwall 12 so that the lower portion of the mounting bracket clears the recess 16 of the channel 14.

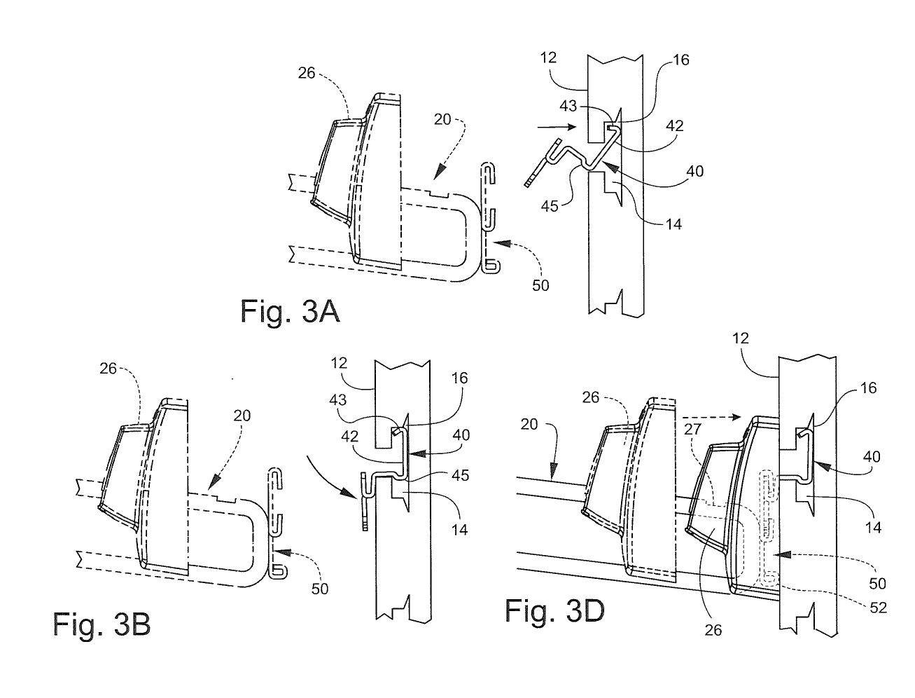

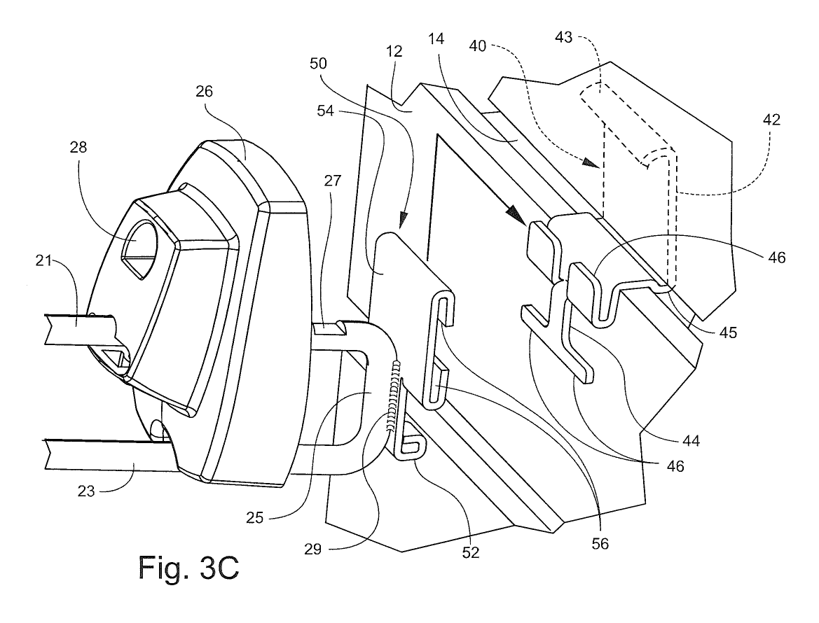

FIG. 3A illustrates the manner in which the mounting bracket 40 is partially positioned within the channel 14 of the slatwall 12. As indicated by the solid-line arrow, the mounting bracket 40 is moved in a horizontal direction towards the slatwall 12 with the mounting bracket tilted to a clockwise angle (as viewed in FIG. 3A) until the flange 43 on the upper portion of the rear wall 42 is partially seated within the upper portion of the recess 16 of the channel 14. The mounting bracket 40 must be tilted sufficiently to permit the flange 45 formed on the lower portion of the rear wall 42 to enter the channel 14. FIG. 3B illustrates the manner in which the mounting bracket 40 is fully positioned within the channel 14 of the slatwall 12. As indicated by the curved solid-line arrow, the mounting bracket 40 is rotated in a counter-clockwise direction (as viewed in FIG. 3B) until the flange 45 formed on the lower portion of the rear wall 42 is fully seated within the lower portion of the recess 16 of the channel 14. At the same time, the flange 43 is fully seated within the upper portion of the recess 16 of the channel 14. At this point, the mounting bracket 40 is fully positioned within the channel 14 of the slatwall 12 and may be moved within the channel in a lateral direction.

FIG. 3C illustrates the manner in which the merchandise display hook 20 is attached to the mounting bracket 40 utilizing a universal adapter 50 according to the invention. As will be readily appreciated by those skilled in the art, the merchandise display hook 30 may be attached to the mounting bracket 40 in the same manner utilizing the universal adapter 50. Accordingly, only the manner of attaching the universal adapter 50 of the merchandise display hook 20 to the mounting bracket 40 need be described in detail herein, the manner of attaching the merchandise display hook 30 to the mounting bracket 40 being the same in all relevant respects. A particular advantage of the invention is that any style or type of merchandise display hook having the universal adapter 50 affixed thereto can be attached to the mounting bracket 40 in the same manner to mount that different display hook to the slatwall 12. Furthermore, the rear wall 42 of the mounting bracket 40 may be configured be received on any other common type of vertical support 10, for example pegboard, wire grid or horizontal bar rack, so that a merchandise display hook including universal adapter 50 may be mounted on any common type of vertical support. In particular, the rear wall 42 may be configured for engagement with any type of vertical support 10, now known or hereafter devised, as long as a front wall 44 is configured to mate with the universal adapter 50, as will be described.

As shown in FIG. 3C, universal adapter 50 comprises a lower portion 52 and an upper portion 54. The adapter 50 is affixed to the merchandise display hook 20 in any suitable manner, for example by welding the display hook and the adapter together along a weld line 29 that extends in a vertical direction between a vertical leg 25 of the display hook and at least a portion of the lower portion 52 and/or the upper portion 54 of the adapter. Alternatively, the upper rod 21, the lower rod 23, the vertical leg 25 and the adapter 50 may be formed as an integral structure in a casting, molding or machining process. Regardless, a mounting flange 40 according to the invention includes a front wall 44 having attachment rails 46 configured for engagement with complimentary attachment tracks 56 provided on the upper portion 54 of the adapter 50. As indicated by the solid-line arrow, the upper portion 54 of the adapter 50 is positioned laterally alongside the front wall 44 of the mounting bracket 40 with attachment tracks 56 of the adapter adjacent the attachment rails 46 of the mounting bracket. The upper portion 54 of the adapter 50 is then moved in a lateral direction until the attachment rails 46 of the mounting bracket 40 are received within the attachment tracks 56 of the adapter 50 in an engagement commonly referred to as “close clearance” or “light interference.” The engagement of the attachment rails 46 with the attachment tracks 56, in combination with the rear wall 42 of the mounting bracket 40 being secured within the channel 14 of the slatwall 12, provides sufficient structural integrity and torsional stability such that the display hook 20 cannot easily be twisted to dislodge the display hook from the slat wall. In addition, the rear wall 42 of the mounting bracket 40 in combination with the lower portion 52 of the adapter 50 provides sufficient structural integrity and bending resistance to prevent the display hook 20 from being easily tilted in a downwards direction.

FIG. 3D illustrates the manner in which the lockable base 26 disposed on the merchandise display hook 20 is positioned to lock the display hook to the slatwall 12. As indicated by the broken lines, the lockable base 26 is initially in the unlocked position on the display hook 20 while the universal adapter 50 is being attached to the mounting bracket 40, in the manner previously described. As indicated by the broken-line arrow, the lockable base 26 is thereafter moved (i.e. slid) along the display hook 20 in a substantially horizontal direction from the unlocked position until the magnetically attractable locking member engages a notch 27 (also shown in FIG. 3C) on the display hook and the lockable base is in the locked position. In the locked position, the lockable base 26 is in relatively flush-mounted engagement with the slatwall 12 (or other type of vertical support 10) so that the display hook 20 (or different type of merchandise display hook, e.g. display hook 30) cannot easily be tilted upwards or downwards to dislodge the display hook from the slatwall. As best seen in FIG. 3D, the lower portion 52 of the adapter 50 likewise is in relatively flush-mounted engagement with the slatwall 12 so as to resist a downward force on the display hook 20 that may dislodge the mounting bracket 40 from the channel 14 of the slatwall 12. In this manner, the display hook 20 is securely mounted to the slatwall 12. In addition, friction between the lockable base 26 and the slatwall 12 resists movement of the display hook 20 in the lateral direction so that the display hook cannot easily be displaced laterally from a desired location on the slatwall.

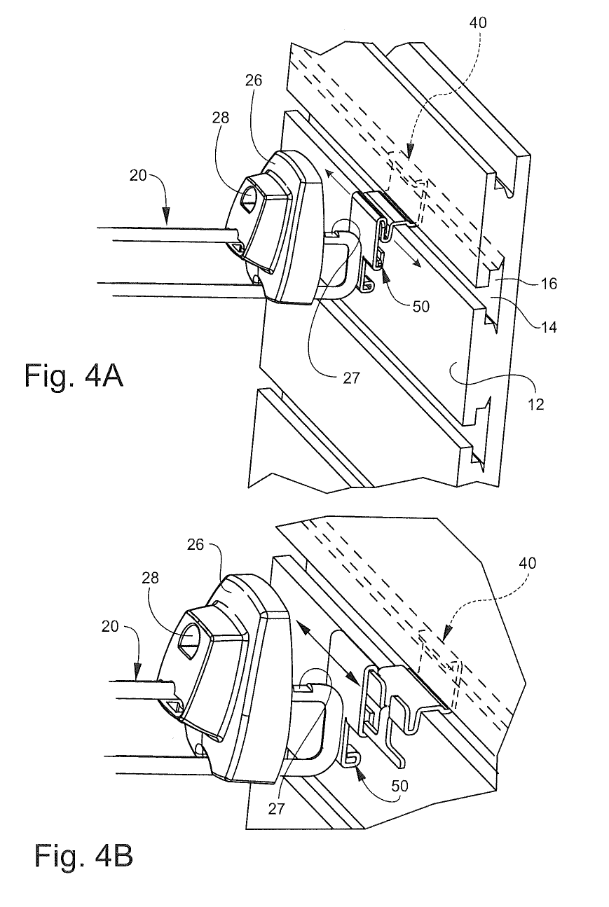

FIG. 4A illustrates the manner in which the merchandise display hook 20 may be displaced laterally by authorized personnel to reposition the display hook on the slatwall 12. A magnetic key (not shown) in possession of an authorized person is inserted into the D-shaped recess 28 on the lockable base 26 to release the magnetically attractable locking member from the notch 27 on the display hook. The lockable base 26 is then moved (i.e. slid) along the display hook 20 from the locked position to the unlocked position shown in FIG. 4A. At this point, the mounting bracket 40 and the universal adapter 50 (attached to the mounting bracket, as previously described) may easily be moved along with the display hook 20 in a lateral direction indicated by the solid-line arrows to reposition the display hook on the slatwall 12. In some instances, sliding of the adapter 50 and mounting bracket 40 may occur without unlocking the lockable base 26 on the display hook 20. In this case, the location of the entire assembly (i.e. mounting bracket 40 and display hook 20 with adapter 50) may be adjusted in a lateral direction a minimal distance without requiring the use of a magnetic key, while the items of merchandise remain secured on the display hook.

FIG. 4B illustrates the manner in which the universal adapter 50 may be displaced laterally by authorized personnel to remove the merchandise display hook 20 from the mounting bracket 40. By way of example only, the display hook 20 may be removed and replaced with a different type of merchandise display hook (e.g. merchandise display hook 30). Alternatively, the display hook 20 may be readily removed and replaced with a merchandise display hook of the same type supporting different items of merchandise. Regardless, a magnetic key (not shown) in possession of an authorized person is inserted into the D-shaped recess 28 on the lockable base 26 to release the magnetically attractable locking member from the notch 27 on the display hook. The lockable base 26 is then moved (i.e. slid) along the display hook 20 from the locked position to the unlocked position shown in FIG. 4B. At this point, the adapter 50 may be moved in a lateral direction indicated by the double-headed solid-line arrow to remove the adapter along with the display hook 20 from the mounting bracket 40. A replacement merchandise display hook including a universal adapter 50 according to the invention then can readily be attached to the mounting bracket 40, as previously described with respect to FIG. 3C.

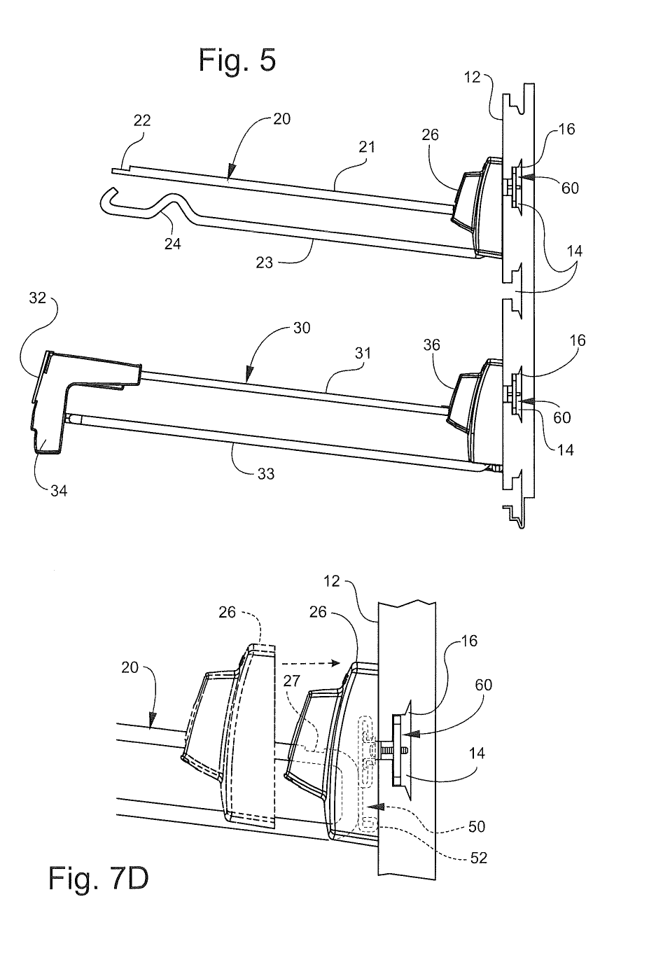

FIG. 5 is a side view showing the merchandise display hooks 20, 30 mounted within vertically-spaced, horizontally-extending channels 14 on the slatwall 12 by a second embodiment of a mounting bracket 60 according to the invention. As shown, the mounting bracket 60 is formed with a shape configured to engage a recess 16 formed within the channel 14. In particular, the mounting bracket 60 comprises a rotatable mounting member that is inserted into the channel 14, rotated to be positioned within the upper and lower recesses 16, and then drawn in a horizontal direction into secure engagement with the interior of the channel 14. The mounting bracket 60 is removable from the channel 14, as will be described in further detail, by reversing the steps to first loosen the mounting member from secure engagement with the interior of the channel, and to then rotate the mounting member out of position within the recesses so that the mounting member clears the recesses and the mounting bracket may be removed from the slatwall 12.

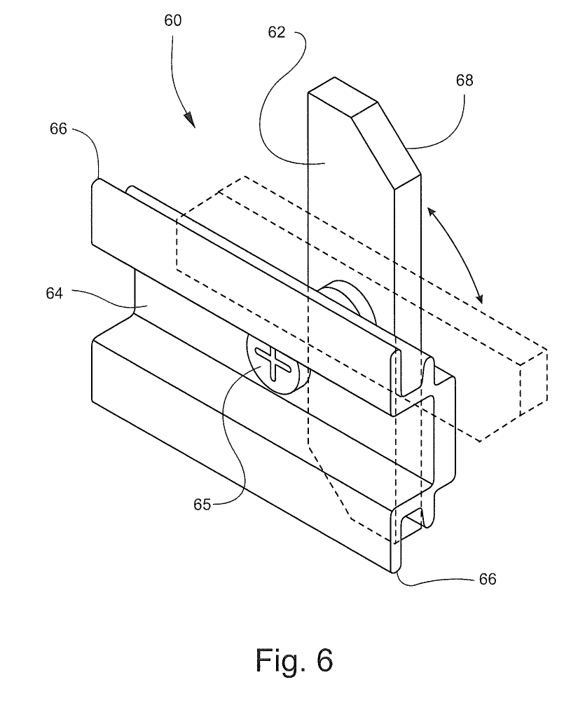

FIG. 6 shows the mounting bracket 60 in greater detail. As shown, the mounting bracket 60 comprises a mounting plate 62 rotatably disposed on a body portion 64 of the mounting bracket. The mounting plate 62 is affixed to a fastener 65 that is rotatably disposed within an opening (not shown) formed through the body portion 64. The fastener 65 is provided with a head configured to be engaged by a tool, and preferably a special tool that is readily available only to authorized personnel, to rotate the fastener and the mounting plate 62 relative to the body portion 64, as indicated by the double-headed, curved solid-line arrow in FIG. 6. The fastener 65 is rotatable in a clockwise direction or a counter-clockwise direction (as viewed in FIG. 6) to alternatively position the mounting plate 62 generally parallel to the elongated dimension of the body portion 64, as indicated by broken lines, and generally perpendicular to the elongated dimension of the body portion, as indicated by solid lines. Preferably, rotation of the mounting plate 62 tends to draw the body portion 64 of the mounting bracket 60 into relatively tight engagement, commonly referred to as an “interference fit,” with the slatwall 12. The mounting bracket 60 further comprises upper and lower attachment rails 66 for engaging the attachment tracks 56 of the universal adapter 50 in the manner previously described to attach the universal adapter 50 to the mounting bracket 60. If desired, the opposed ends of the mounting plate 62 may be formed with a chamfer 68 to assist the mounting plate entering and exiting the recesses 16 of the channel 14 in a preferred direction. Furthermore, the mounting plate 62 may utilize additional surfaces or include additional features to assist in securing the mounting bracket 60 within the channel 14 of the slatwall 12, for example by friction.

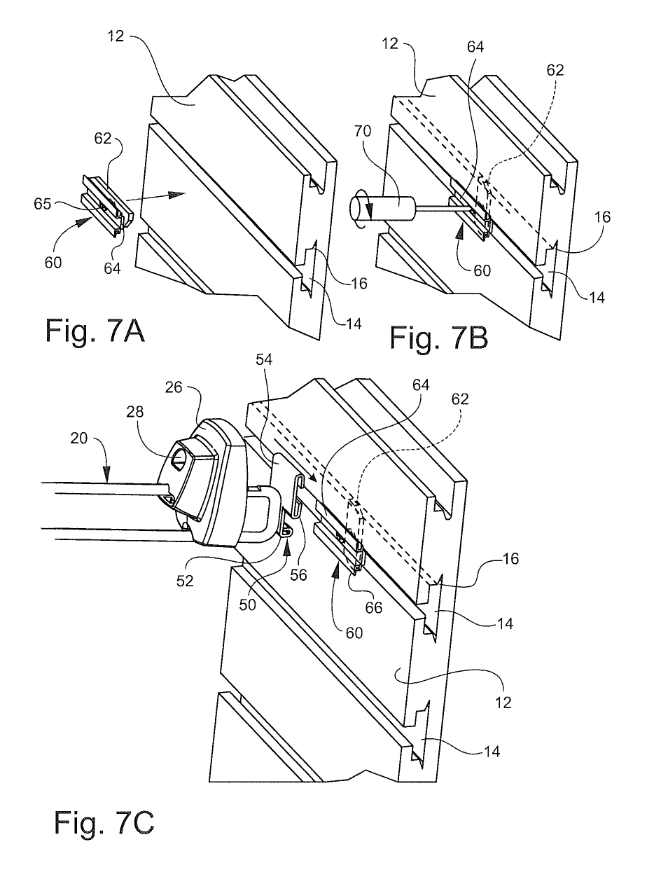

FIG. 7A illustrates the manner in which the mounting bracket 60 is initially positioned within the channel 14 of the slatwall 12. As indicated by the solid-line arrow, the mounting bracket 60 is moved in a horizontal direction towards the slatwall 12 with the mounting plate 62 oriented generally parallel to the elongated dimension of the body portion 64 until the mounting plate is partially seated within the channel 14. The mounting bracket 60 must be inserted with the elongated dimension of the body portion 64 sufficiently parallel to the channel 14 to permit the rear of the body portion to properly seat within the channel on the slatwall 12. FIG. 7B illustrates the manner in which the mounting bracket 60 is fully positioned within the channel 14 of the slatwall 12. As indicated by the curved solid-line arrow, a special tool 70 engaging the head of the fastener 65 of the mounting bracket 60 is rotated in a clockwise direction (as viewed in FIG. 7B) until the opposed ends of the mounting plate 62 enter the upper and lower recesses 16 of the channel 14. It will be readily appreciated that the fastener 65 may be rotated in a counter-clockwise direction (i.e. left-hand fastener), if desired. The special tool 70 is then further rotated in the clockwise direction to draw the mounting plate 62 into secure engagement with the interior of the channel 14. At the same time, the rear of the body portion 64 of the mounting bracket 60 is fully seated within the channel 14 of the slatwall 12. At this point, the mounting bracket 60 is fully positioned within the channel 14 of the slatwall 12 and typically is not movable within the channel in a lateral direction.

FIG. 7C illustrates the manner in which the merchandise display hook 20 is attached to the mounting bracket 60. As will be readily appreciated, a different merchandise display hook (e.g. display hook 30) may be attached to the mounting bracket 60 in substantially the same manner utilizing a universal adapter 50 according to the invention. Accordingly, only the manner of attaching the merchandise display hook 20 need be described in detail herein, the manner of attaching the merchandise display hook 30 to the mounting bracket 60 being substantially the same in all relevant respects. A particular advantage of the invention is that any style or type of merchandise display hook having the universal adapter 50 affixed thereto can be attached to the mounting bracket 60 in substantially the same manner to mount that display hook to the slatwall 12. Furthermore, the mounting plate 62 of the mounting bracket 60 may be configured to be received on another vertical support 10, for example pegboard, wire grid or horizontal bar rack, so that a merchandise display hook including universal adapter 50 may be mounted on any common type of vertical support. In particular, the mounting plate 62 may be configured for engagement with any vertical support 10, as long as body portion 64 is configured to mate with universal adapter 50, as will be described with reference to FIG. 7C.

As shown in FIG. 7C, universal adapter 50 comprises a lower portion 52 and an upper portion 54 having attachment tracks 56 previously described. A mounting bracket 60 according to the invention includes a body portion 64 having attachment rails 66 configured for engagement with the attachment tracks 56 provided on the upper portion 54 of the adapter 50. As indicated by the solid-line arrow, the upper portion 54 of the universal adapter 50 is positioned laterally alongside the body portion 64 of the mounting bracket 60 with the attachment tracks 56 of the upper portion adjacent the attachment rails 66 of the mounting bracket. The upper portion 54 of the adapter 50 is then moved in a lateral direction until the attachment rails 66 of the mounting bracket 60 are received within the attachment tracks 56 of the adapter in an engagement commonly known as “close clearance” or “light interference.” The engagement of the attachment rails 66 with the attachment tracks 56, in combination with the body portion 64 of the mounting bracket 60 being secured within the channel 14 of slatwall 12, provides sufficient structural integrity and torsional stability such that the display hook 20 cannot easily be twisted to dislodge the display hook from the slat wall. In addition, the mounting plate 62 of the mounting bracket 60 disposed within the recesses 16 of channel 14 in combination with the lower portion 52 of the adapter 50 provides sufficient structural integrity and bending resistance to prevent the display hook 20 from being easily tilted in an upwards or downwards direction.

FIG. 7D illustrates the manner in which the lockable base 26 disposed on the merchandise display hook 20 is positioned to lock the display hook to the slatwall 12. As indicated by the broken lines, the lockable base 26 is initially in the unlocked position on the display hook 20 while the universal adapter 50 is being attached to the mounting bracket 60, in the manner previously described. As indicated by the broken-line arrow, the lockable base 26 is moved (i.e. slid) along the display hook 20 in a substantially horizontal direction from the unlocked position until the magnetically attractable locking member engages notch 27 on the display hook and the lockable base is in the locked position. In the locked position, the lockable base 26 is in relatively flush-mounted engagement with the slatwall 12 (or other common type of vertical support 10) so that the display hook 20 (or a different merchandise display hook, e.g. display hook 30) cannot easily be tilted upwards or downwards to dislodge the display hook from the slatwall. As best seen in FIG. 7D, the lower portion 52 of the adapter 50 likewise is in relatively flush-mounted engagement with the slatwall 12 so as to resist a downward force on the display hook 20 that may dislodge the mounting bracket 60 from the channel 14 on the slatwall 12. In this manner, the display hook 20 is securely mounted to the slatwall 12. In addition, friction between the lockable base 26 and the slatwall 12 resists movement of the display hook 20 in the lateral direction so that the display hook cannot easily be displaced laterally from a desired location on the slatwall.

The foregoing has described one or more exemplary embodiments of a merchandise display hook including a universal adapter cooperating with a mounting bracket for readily mounting the display hook to a common type of a vertical support. In preferred embodiments, the invention is a merchandise display hook including a universal adapter and a mounting bracket configured for mounting the display hook to slatwall from a lateral direction. While particular exemplary embodiments of the present invention have been described, it will be apparent to those skilled in the art that various modifications thereto can be made without departing from the spirit and scope of the invention. Accordingly, the foregoing detailed description of preferred embodiments of the invention and the best mode for practicing the invention are provided for the purpose of illustration only, and not for the purpose of limitation. In particular, it will be readily understood and appreciated by those skilled in the art that a universal adapter and a mounting bracket in accordance with the invention may be configured for use with alternate types of merchandise display hooks and may be configured to mount various types of merchandise display hooks to alternate types of vertical supports, including but not limited to pegboard, wire grid and horizontal bar rack, without departing from the spirit and scope of any of the appended claims of this application.

That which is claimed is:

1. A merchandise display hook for supporting and displaying items of merchandise, the display hook comprising:
at least one rod extending outwardly from a generally vertical support;
a universal adapter attached to the at least one rod; and
a mounting bracket for mounting the display hook to the support, the mounting bracket configured to be received on the support and configured to receive the universal adapter thereon from a generally lateral direction.

2. A merchandise display hook according to claim 1,
wherein the mounting bracket comprises a front wall disposed outwardly from the support having at least one attachment rail; and
wherein the universal adapter comprises at least one attachment track for engaging the at least one attachment rail of the mounting bracket.

3. A merchandise display hook according to claim 2, wherein the attachment track of the universal adapter is complimentary in shape to the attachment rail of the mounting bracket.

4. A merchandise display hook according to claim 1, further comprising a lockable base for locking the display hook to the support.

5. A merchandise display hook according to claim 4, wherein the lockable base is movably disposed on the rod between an unlocked position and a locked position, and wherein the lockable base prevents access to the universal adapter in the locked position.

6. A merchandise display hook according to claim 5, wherein the lockable base comprises a magnetically attractable locking member for engaging the rod to lock the lockable base on the rod, and wherein a magnet is operable for releasing the locking member from engagement with the rod to unlock the lockable base from the rod.

7. A merchandise display hook according to claim 4, wherein the lockable base prevents the display hook from being tilted upwards or downwards to dislodge the display hook from the support.

8. A merchandise display hook according to claim 2, wherein the universal adapter comprises an upper portion having a pair of attachment tracks for engaging a complimentary pair of attachment rails of the mounting bracket, and further comprises a lower portion for engaging the support to prevent the display hook from being tilted downwards to dislodge the display hook from the support.

9. A merchandise display hook according to claim 2, wherein the mounting bracket further comprises a rear wall having a flange disposed on an upper portion for engaging a channel formed in the support and a flange disposed on a lower portion for engaging the channel formed in the support.

10. A merchandise display hook according to claim 2, wherein the mounting bracket comprises a body portion having a pair of attachment rails for engaging a complimentary pair of attachment tracks of the universal adapter, and further comprises a mounting plate for engaging a channel formed in the support.

11. A merchandise display hook according to claim 10, wherein the mounting plate is movably mounted on the body portion of the mounting bracket and is movable relative to the body portion within the channel to secure the mounting bracket on the support.

12. A universal adapter and mounting bracket assembly for a merchandise display hook comprising:
an adapter attached to a rear portion of the merchandise display hook, the adapter comprising one of an attachment track and an attachment rail; and
a mounting bracket configured for attachment to the support and comprising the other of the attachment track and the attachment rail;
wherein the one of the attachment track and the attachment rail of the adapter engages the other of the attachment track and the attachment rail of the mounting bracket from a generally lateral direction to mount the display hook on a support.

13. The assembly of claim 12, further comprising a lockable base movable between an unlocked position and a locked position to lock the display hook on the support and thereby prevent the display hook from being tilted upwards or downwards to dislodge the display hook from the support.

14. The assembly of claim 12, wherein the adapter and the mounting bracket are configured to prevent the display hook from being twisted or rotated to dislodge the display hook from the support when the adapter is engaged with the mounting bracket.

15. The assembly of claim 12, wherein the adapter comprises an upper portion having a pair of attachment tracks and the mounting bracket comprises a complimentary pair of attachment rails, and wherein the adapter further comprises a lower portion for engaging the support to prevent the display hook from being tilted downwards to dislodge the display hook from the support.

16. The assembly of claim 12, wherein the mounting bracket further comprises a rear wall having a flange disposed on an upper portion for engaging a channel formed in the support and a flange disposed on a lower portion for engaging the channel formed in the support.

17. The assembly of claim 12, wherein the mounting bracket comprises a body portion having a pair of attachment rails and the adapter comprises a complimentary pair of attachment tracks, and wherein the mounting bracket further comprises a mounting plate movably disposed on the mounting plate for engaging a channel formed in the support to secure the mounting bracket on the support.

18. An adapter configured to engage a mounting bracket for mounting a merchandise display hook to a generally vertical support, the adapter comprising:
an upper portion having a pair of vertically spaced attachment tracks for receiving a complimentary pair of attachment rails disposed on the mounting bracket; and
a lower portion defining a mechanical stop for engaging the support to thereby prevent the merchandise display hook from being tilted downwards to dislodge the display hook from the support.

19. An adapter according to claim 18, wherein the display hook comprises a lockable base that is movable on the display hook between an unlocked position and a locked position that prevents access to the adapter to thereby prevent the adapter from being removed from the mounting bracket.

20. A method of mounting a merchandise display hook to a generally vertical support comprising:
providing a merchandise display hook having a universal adapter attached thereto and a lockable base that is movable between an unlocked position and a locked position;
providing a mounting bracket configured for attachment to the support;
attaching the mounting bracket to the support;
engaging one of an attachment track and an attachment rail of the universal adapter with the other of the attachment track and the attachment rail of the mounting bracket to attach the universal adapter to the mounting bracket and thereby mounting the display hook on the support; and
moving the lockable base from the unlocked position to the locked position to thereby prevent access to the attachment track and the attachment rail of the universal adapter and the mounting bracket.
